(19) United States
(12) Patent Application Publication
(10) Pub. No.: US 2013/0317805 A1
(43) Pub. Date: Nov. 28, 2013

(54) SYSTEMS AND METHODS FOR DETECTING REAL NAMES IN DIFFERENT LANGUAGES

(71) Applicants: Keith Patrick ENRIGHT, San Francisco, CA (US); Dan FREDINBURG, San Francisco, CA (US); Andrew SWERDLOW, San Francisco, CA (US)

(72) Inventors: Keith Patrick ENRIGHT, San Francisco, CA (US); Dan FREDINBURG, San Francisco, CA (US); Andrew SWERDLOW, San Francisco, CA (US)

(73) Assignee: GOOGLE INC., Mountain View, CA (US)

(21) Appl. No.: 13/480,094

(22) Filed: May 24, 2012

(51) Int. Cl. G06F 17/27

(52) U.S. Cl. 704/9

(57) ABSTRACT

Systems and methods for detecting real names in different languages are described, including receiving a candidate name; determining a human language of the candidate name; disassembling a structure of the candidate name by applying a rule base for at least one of a character set, a meaning, and a format of the candidate name, wherein the rule base is unique to the determined human language; verifying at least a part of the disassembled structure of the candidate name with respect to actual real name information to generate a degree of confidence that the candidate name is the an actual real name; and performing an action based on the generated degree of confidence that the candidate name is the actual real name.

### BACKGROUND

1. Technical Field

The subject matter discussed herein relates generally to data processing and, more particularly, to systems and methods for detecting real names in different languages.

2. Background Information

Online products and services often require users to provide their real names. While some users provide their real names correctly, other users do not provide their real names correctly. The reason may be unintentional (e.g., typographical error) or intentional (e.g., to hide their identities). Some users may provide names that are not real names. Accordingly, there is no indication whether the names provided by the users are real or not.

Further, the provided names may be in different languages, which are associated with different cultures, traditions, and customs. Names in some languages may include a surname. For example, the surname may be provided as the first word, the last word, or a word in between the first and last words. In some languages, there is no notion of a surname.

Real names in different languages as used in online products and services are hard to detect. A solution is needed.

### SUMMARY

Systems and methods for detecting real names in different languages are described. The subject matter includes at least a computing device, at least a computer product, and at least a method for receiving a candidate name; determining a human language of the candidate name; disassembling a structure of the candidate name by applying a rule base for at least one of a character set, a meaning, and a format of the candidate name, wherein the rule base is unique to the determined human language; verifying at least a part of the disassembled structure of the candidate name with respect to actual real name information to generate a degree of confidence that the candidate name is the an actual real name; and performing an action based on the generated degree of confidence that the candidate name is the actual real name.

### BRIEF DESCRIPTION OF THE DRAWINGS

FIG. 1A shows an example online environment in which some example embodiments may be implemented and/or operated.

FIG. 1B shows example data flow in an example online environment in which names may be processed.

FIGS. 2A-E show example processing flows of some example embodiments.

FIG. 3 shows an example process suitable for implementing at least one example embodiment.

FIG. 4 shows an example computing environment with an example computing device suitable for implementing at least one example embodiment.

### DETAILED DESCRIPTION

The subject matter described herein is taught by way of example embodiments. Various details have been omitted for the sake of clarity and to avoid obscuring the subject matter. Examples shown below are directed to structures and functions of systems and methods for detecting real names in different languages.

As used herein, a “real name” is a publicly known or legal identifier of a person. The publicly known or legal identifiers of some people may be the same. For other people (e.g., artists), their publicly know identifiers may not be the same as their legal identifiers. For example, a singer may be publicly known by a stage name, which may be different from a legal name (e.g., name on passport).

Example Processing Environment

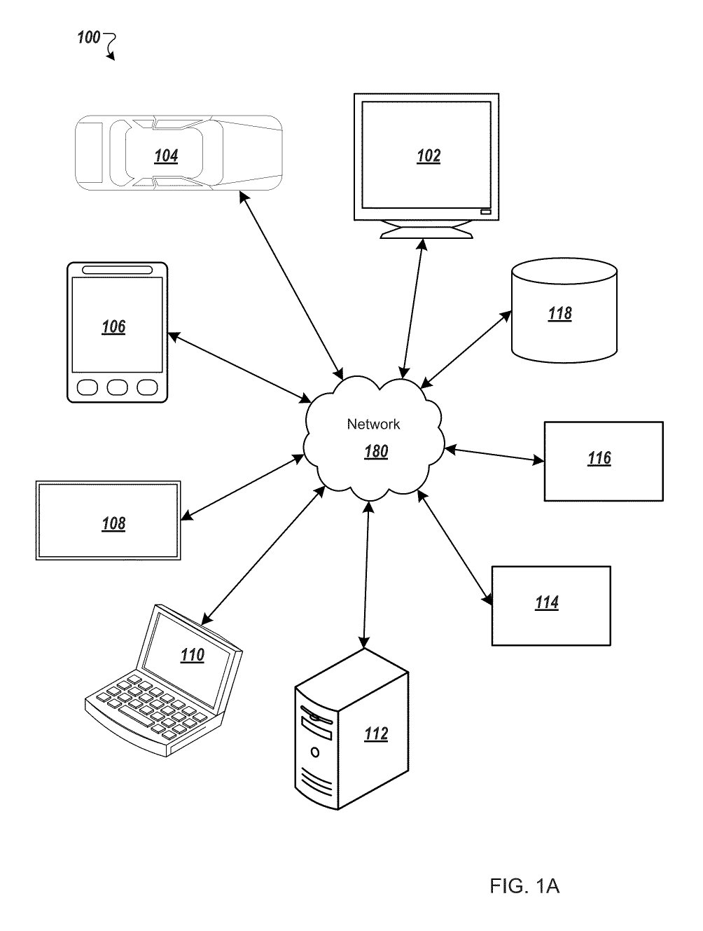

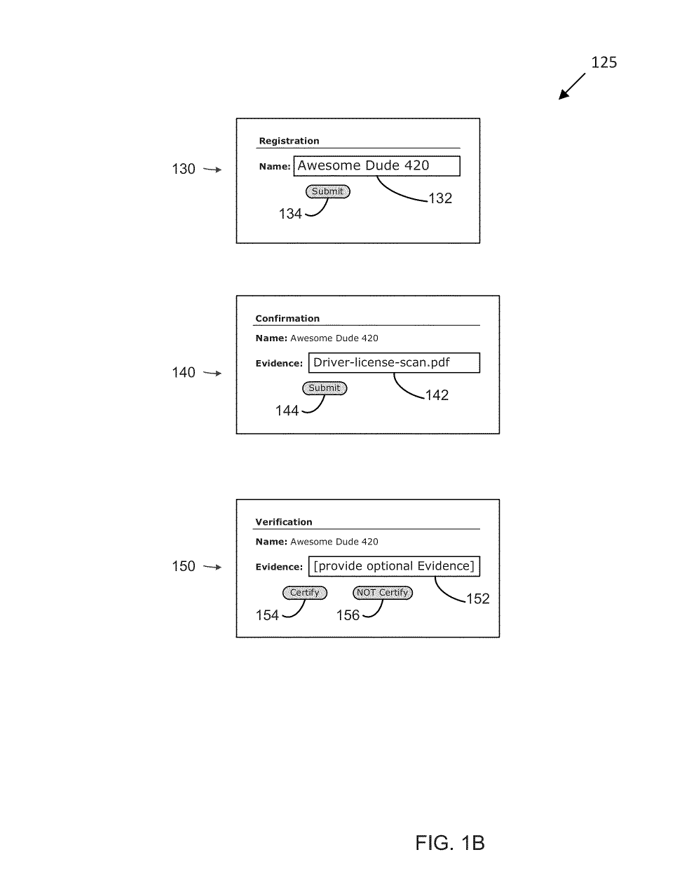

FIG. 1A shows an example online environment in which some example embodiments may be implemented and/or operated. Environment 100 includes devices 102-118, each is communicatively connected to at least one other device via, for example, network 180. Some devices may be communicatively connected to one or more storage devices 118.

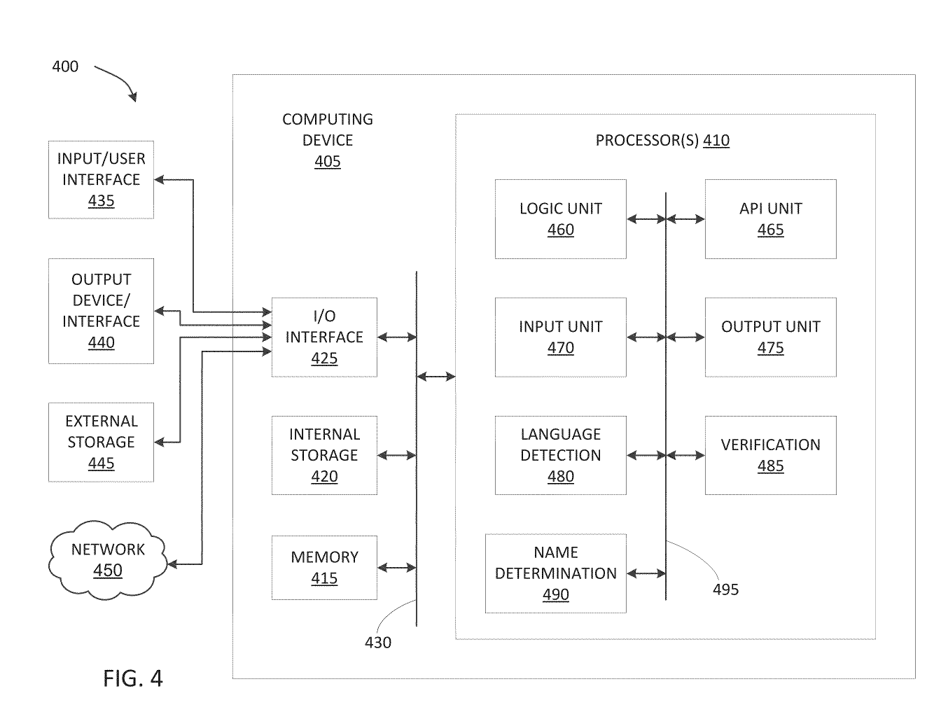

An example of one or more devices 102-118 may be computing device 405 (FIG. 4). Devices 102-118 may include, but are not limited to, a computer 102 (e.g., personal or commercial), a device in a vehicle 104, a mobile device 106 (e.g., smartphone), a television 108, a mobile computer 110, a server or desktop computer 112, computing devices 114-116, storage devices 118. Any of devices 102-118 may access one or more services from and/or provide one or more services to one or more devices shown in environment 100 and/or devices not shown in environment 100.

FIG. 1B shows example data flow in an example online environment in which names may be processed. In environment 125, data may flow (e.g., through network 180 as shown in FIG. 1) between user interfaces 130, 140, and 150 and a third party provider (not shown) and a service provider (not shown). User interfaces 130, 140, and 150 may be provided on some devices (e.g., devices 102-110, FIG. 1A) and may represent different points along a timeline. The third party provider and service provider may be embodied in, for example, devices 112-118 (FIG. 1) and/or those not shown.

User interface (UI) 130 illustrates a mechanism for a user to provide his or her name. The user may be providing the name for any reason (e.g., registering for a product or service, opening an account, responding to a survey, etc.). For simplicity, other information (not shown, e.g., contact information) may be included, as would be understood by one skilled in the art. The user may enter their name, for example, using widget 132 (e.g., a text box, auto-fill feature, voice input widget, etc.), and activate control 134 to submit or provide their name.

UI 140 illustrates a mechanism a user may use to provide evidence or proof to support that his or her name is real. For example, the user may input evidence 142 and submit it using control 144. Further details of UI 140 are discussed in greater detail below.

UI 150 illustrates a mechanism an administrator or third-party user may use to verify whether a name is real. For example, if the name is real, the name may be confirmed or verified using control 154. If the name is not real, the name may be so indicated or rejected using control 156. Optionally, evidence 152 may be provided with either control 154 or 156. Further details of UI 150 are discussed in greater detail below.

Example Real Name Detection Process

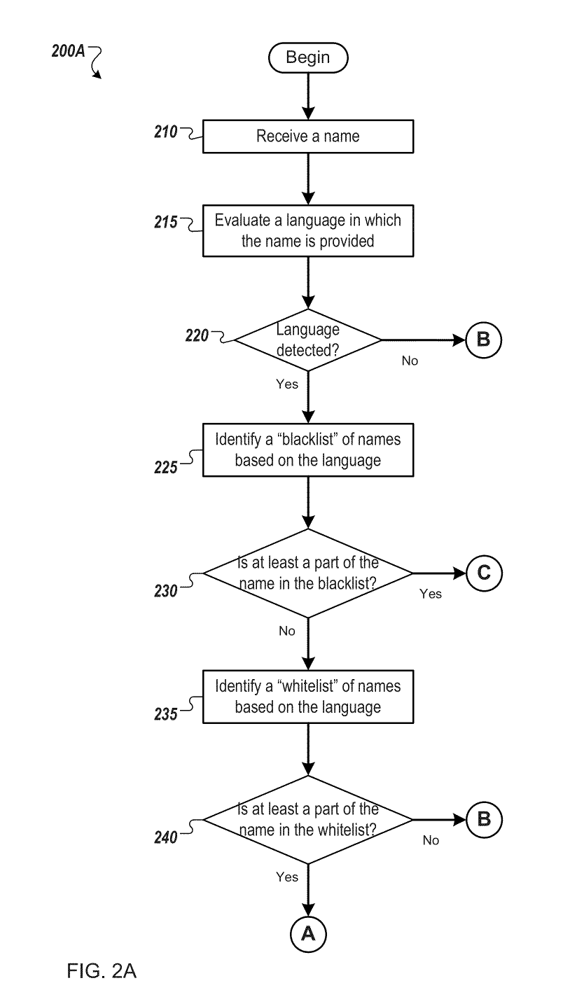

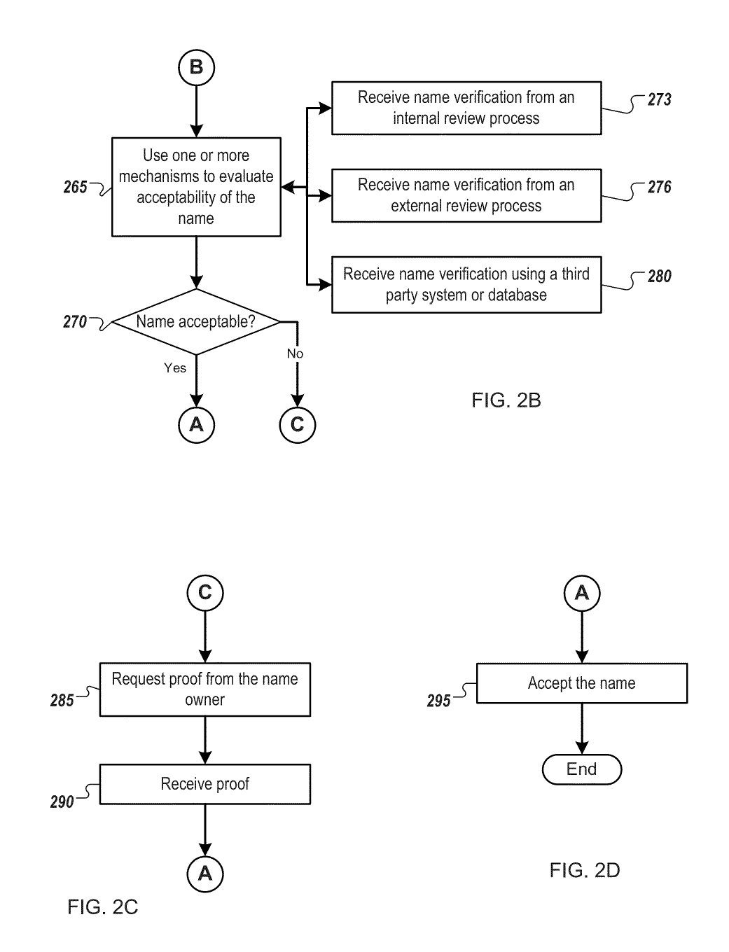

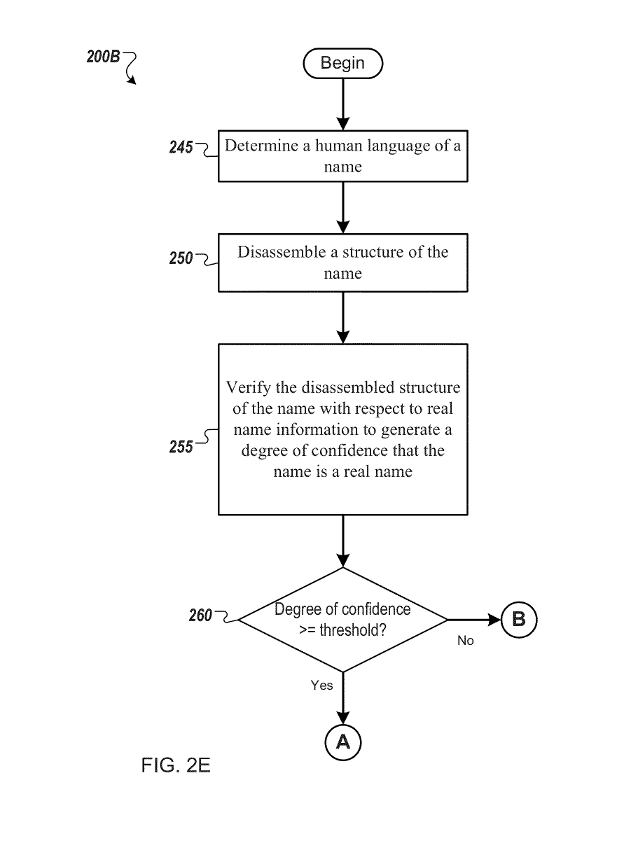

To illustrate some example embodiments, elements of FIG. 1B are described in conjunction with FIG. 2A. As shown in FIG. 2A, at block 210, a service provider (not shown) may receive the user's name. The service provider may evaluate, identify, and/or detect (evaluate) the language (e.g., human language) in which the name is provided (block 215). For example, an evaluation may be performed on a provided name such as “Glenn Smith” (English), or “ [symbol] ” (Japanese), or a name in yet another language.

The language may be evaluated in any manner. In some example embodiments, language evaluation may be performed using Unicode scripts (accessible on the Internet at www dot unicode dot org). Unicode has defined ranges of codes for different languages or sets of languages. For example, one range (e.g., 4E00-9FCF, in hexadecimal) has been defined for Chinese ideographs in version 6.1 of The Unicode Standard. This range of codes can be used to represent the Chinese ideographs used in the Chinese language, Japanese language, and Korean language (CJK). There are other CJK ranges of codes (e.g., CJK Extension A to CJK Extension D, etc.), Japanese ranges of codes (e.g., Hiragana and Katakana), Korean ranges of codes (e.g., Hangul ranges), and numerous other ranges of codes.

To evaluate the language of a provided name, for example, the range or ranges of codes are identified. Using the name “ [symbol] ” as an example, some characters (e.g., “ [symbol] [symbol] ”) are identified to be in a CJK range and some characters (e.g., “ [symbol] ”) are identified to be in a Hiragana range. Collectively, since the Japanese language uses Kanji (or Chinese characters) and the Chinese language does not use any Japanese character, the name “ [symbol] [symbol] ” can be concluded with a high degree of confidence that it is a Japanese name.

A Korean name can be evaluated (e.g., detected) by identifying that the name is represented by codes in a Korean range or in a combination of a Korean range and a CJK range. A Chinese name can be detected based on the name being represented by one or more CJK ranges. As used herein, the term “language” or “human language” refers to a collection of symbols used by human in communication.

Example of List of Names

The service provider may have access to one or more databases of name information for each language. For example, for the Japanese language, there may one or more databases of name information that can be characterized with a degree of confidence as not being components of the real name (e.g., “blacklist” of Japanese non-real names or components thereof). The blacklist may be a repository of non-real names or components thereof previously determined or detected to be non-real. The blacklist may include non-real names or components thereof collected from one or more sources (e.g., the Internet).

The blacklist may be built or expanded by any methods, using any mechanisms, using information from any sources, or any combination thereof. For example, the blacklist may be created, built, added to, expanded with known fake names or fake name components located on the Internet, derived by a spam filter, imported from a government database (e.g., a fraud information database), detected by the service provider (e.g., in a confirmation or verification process), or gained from another source or method.

If it is determined that the language of the provided name is detected based on the above-described evaluation (block 220), the service provider may identify the “blacklist” of non-real names and components thereof based on the detected language (block 225). Once the language has been detected or determined, one or more language specific rules and/or databases may be used to determine whether the provided name is a real name. For example, the language of the provided name detected may be Japanese (e.g., the provided name is encoded in a Japanese script or Unicode). Then, one or more databases or blacklists of candidate names and/or components thereof in the Japanese language are identified (e.g., identifying the databases of names and/or components thereof in Japanese, as opposed to the databases of those in English, Korean, Chinese, or another language). The provided name or part thereof (e.g., the part that represents a surname or given name in Japanese) may be compared against the non-real names and/or components thereof in the Japanese blacklist databases. If, at block 230, it is determined to not be true that at least a part of the provided name is in the blacklist database, process 200A flows to block 235 as explained below.

The one or more databases of name information for each language service provider may have access to may include, for example, one or more databases of name information that are certain to a degree or known for being components of a real name or real names (e.g., “whitelist”). The whitelist may be a repository of names or name components previously detected or determined to be real names or components thereof. The whitelists may be names or name components collected from one or more sources (e.g., the Internet) known to be used in real names (e.g., most common surnames in a given language, popular baby names in a given language, most common first names in a given language, etc.). The whitelists may be built or expanded by any methods, mechanisms, or any combination thereof.

The whitelist may be built or expanded by any methods, using any mechanisms, using information from any sources, or any combination thereof. For example, the whitelist may be created, built, added to, expanded with known real names or real name components located on the Internet (e.g., common Japanese names and common Japanese surnames, etc.), imported from one or more directories (e.g., telephone directories), imported from a government database (e.g., a driver license or identification card database), imported from a third party provider (e.g., purchased form a credit card issuer), detected by the service provider (e.g., in a confirmation or verification process), or gained from another source or method.

The service provider may identify the “whitelist” of real names and components thereof based on the detected language (block 235). For example, the language of the provided name is detected to be Japanese. Then, one or more databases or whitelists of candidate real names and/or components thereof in the Japanese language are identified (e.g., identifying the databases of names and/or names components in Japanese, as opposed to the databases of those in another language, such as English, Korean, Chinese, etc.). The provided name or part thereof (e.g., the part that represents a surname or given name in Japanese) may be compared against the names and/or name components in the Japanese whitelist databases.

Example of Name Acceptance Process

As shown in FIG. 2D, if it has been determined at block 235 of FIG. 2A to be true that at least a part of the provided name is in the whitelist databases, the provided name may be accepted (block 295, sub-process “A”). Accepting a name may include recording the name, storing the name in a database, authorizing an action to open an account or make an online purchase, and/or performing other operations on the name, or based on the name. In some example embodiments, there may be one or more further operations required before accepting a provided name as a real name.

Accepting a provided name as a real name may be based on a degree of certainty or confidence that the provided name or a component thereof is real and/or not real (e.g., accepting or rejecting a name if the degree of certainty that the name or one of its component is 70% certain real and/or 55% certain not real, respectively). In some example embodiments, the degree of certainty (e.g., probability) that a name or name component is real or not real may increase after comparing the name or name component to the content of a successive whitelist or blacklist, respectively. The degrees of confidence for any language may be set or changed to any thresholds or levels, and the degrees for different languages may be different.

Example Implementation

The service provider may implement methods, objects, or application programming interface (API) for use in identifying real names. Below is one of many possible implementation examples, as would be understood by one skilled in the art, for detecting real names in different languages.

```
virtual bool MarkUpAllNames (
    const string& candidate,
    const string& language,
    vector<linked_ ptr<NameOccurrence> >* result)
```

| Parameter | Meaning |
|---|---|
| candidate | The string to find names in. Expect plain text in Unicode |
| | Transformation Format-8 (UTF-8). |
| language | The two-character language code, like “en” or “ru”. The |
| | detector will be using data (e.g., whitelists and/or blacklists) |
| | tuned to that language to detect names. Example language |
| | codes: “pt” for Portuguese, both in Brazil and in Portugal, |
| | “zh” for Simplified Chinese, and “zh-TW” for Traditional |
| | Chinese. |
| result | A vector where the results will be returned. |

The example MarkUpAllNames method can be implemented to best match the set of names provided in the “candidate” variable and returned all potential names and name components in the “result” variable. For example, a call is made as: MarkUpAllNames(“Nicolas Sarkozy”, “en”). The MarkUpAllNames method parses “Nicolas Sarkozy” into “Nicolas” and “Sarkozy”. The language indicator “en” signifies that the language of “Nicolas Sarkozy” has been evaluated and detected to be English. MarkUpAllNames then identifies and uses one or more blacklists and/or whitelists pertaining to the English language.

The MarkUpAllNames method may not locate “Nicolas” and/or “Sarkozy” in any blacklist. The MarkUpAllNames method may locate “Nicolas” and/or “Sarkozy” in one or more whitelists, and return in the “result” variable the following:

```
weight: 6.9
NamePart {
        start_index: 0
        end_index: 7
        text: “Nicolas”
        part_type: FIRST_NAME
        abbreviated: false
}
NamePart {
        start_index: 8
        end_index: 15
        text: “Sarkozy”
        part_type: LAST_NAME
        abbreviated: false
}
```

As an example of the returned NameOccurrence may be:

| Field | Meaning |
|---|---|
| weight | The score or degree of certainty MarkUpAllNames assigns |
| | to the name or name component. The higher the score is, |
| | the higher the degree of certainty that the name is real. The |
| | range of scores may be implemented to be any range (e.g., |
| | between 0.0 and 10.0, in this example). |
| NamePart | Each represents a name component or the smallest logical |
| | part of the name (e.g., a first name or last name). Note |
| | that this can be more than one word. For example, in Dutch |
| | a last name like “van Basten” may be returned as one part. |
| | On the other hand, there can be several last name |
| | NameParts (for example, if a person has several last |
| | names). |
| start_index, | Those point to the position in the original string (e.g., |
| end_index | provided in the “candidate” variable) of this part. The |
| | offsets may be in bytes or unicode characters based on the |
| | language. |
| text | The content of this NamePart. Note that this can be slightly |
| | different from the substring represented by (start_index, |
| | end_index) in the original string. For example, if the |
| | original string has “Anna - Maria” as the first name, the |
| | corresponding NamePart's text may be “Anna-Maria” |
| | (note the lack of spaces), according to one implementation. |
| part_type | The type of the part (e.g., first name, last name, middle |
| | name, middle initial, etc.). |
| abbreviated | True if the part is abbreviated. Will be true for initials, for |
| | example. |

In the above example, the provide name “Nicolas Sarkozy” is determined to be a real name with a degree of certainty of 6.9 (in a 10.0 scale). If the threshold is set at 6.8 and below, “Nicolas Sarkozy” may be accepted as a real name in the English language. Real names in other languages (e.g., Japanese) may be determined similarly (e.g., using the same or similar API) or in another fashion.

If the language of the provided name is determined as not detected, at block 220, or if it is determined that no part of the provided name is in any whitelist, at block 240, process 200A may flow to sub-process “B”, as shown in FIG. 2B. The language of a provided name of “TSU93$,” for example, may not be detectable using a reasonable effort. For example, the script used to represent “TSU93$” may be an English script or another script of a Latin-based language. However, “TSU” may also be a Romanized representation of a Japanese syllabogram “ [symbol] ”, in hiragana, or “ [symbol] ” in katakana. One premise of a real name may be that the name is represented in a human language. In the foregoing, it is hard to detect the human language of the string of “TSU93$”.

Verification of Name Acceptability

If a language is determined to have not been detected at block 220, one or more mechanisms to evaluate acceptability of the provided name may be employed (block 265). One example mechanism may be an internal review process. For example, an administrator may use a tool or user interface similar to UI 150 to review a provided name (e.g., “Awesome Dude 420”) and accept or “Certify” it (e.g., using control 154) or reject or “NOT Certify” it (e.g., using control 156). In some example embodiments, the administrator may provide evidence 152 to support his or her decision (e.g., a copy of the name owner's driver license). For example, the administrator may be reviewing a name after the owner of the name have provided a copy of his or her driver license as supporting evidence (see sub-process “C”, described below). The name verification, either “Certify” or “NOT Certify”, may be received by the service provider (block 273). The administrator is a label for a person authorized to review names in an internal review process.

Another example mechanism may be an external review process (block 276). For example, another person (e.g., a friend or family member) acquainted with the person provided the name may be given an opportunity to verify the provided name. The external review process may employ a tool or user interface similar to UI 150, described above. The result of the name verification using the external review process may be received by the service provider (block 276).

Yet another mechanism may be a review process involving a third-party provider and/or database. For example, an agreement may be established to use a third-party provider and/or database (e.g., driver license database) for name verification purposes. The result of name verification (e.g., success, failure, or another status) using a third-party provider and/or database may be received by the service provider (block 280).

Any combination of verification mechanisms may be used, including some or all of the described mechanisms and/or those not described. If the provided name is acceptable (e.g., based on a degree of certainty of the name), at block 270, the provided name may be accepted (block 295, sub-process “A”). If the provided name is deemed not acceptable at block 270 (e.g., an indication of “NOT Certify” 156 is received) or if at least a part of the name is in a blacklist at block 230, process 200A flows to sub-process “C”, as shown in FIG. 2C.

Sub-process “C” as shown in FIG. 2C may include communicating with the user from whom the name is received (e.g., name owner), to request proof to support that the name is real (block 285). For example, the service provider may send an email to the name owner with instructions of providing proof of name. The name owner may use a tool or user interface similar to UI 140 to confirm that the name is real by, for example, submitting evidence.

For example, the owner may provide a copy of the utility bill, driver license, or credit card information, as evidence 142, and activate control 144 to submit the evidence. The evidence or proof may be received (block 290), for example, by the service provider. The provided name may be accepted (block 295, sub-process “A”). The evidence may verify or prove that the provided name is a real name. In some situations, a user may provide an evidence of a real name that is different from the provided name. In some example embodiments, the received evidence or proof may be reviewed before accepting the provided name as a real name.

The example embodiment is not limited to the foregoing sequence of blocks, and any other sequence may be implemented. For example but not by way of limitation, instead of flowing to sub-process “C” of FIG. 2C, process 200A may instead flow to sub-process “C” (shown in FIG. 2C) from block 220 or block 240.

Example Process for Disassembling Name Structure

FIG. 2E shows another example process suitable for implementing at least one example embodiment. A name in any language may be received at the service provider. The service provider may determine or detect the language (e.g., human language) of the name (245). Once the language has been detected or determined, one or more language specific rules and/or databases may be used to determine whether the provided name is a real name. For example, the detected language may be Japanese. One of Japanese-language specific rules may be that a Japanese name (e.g., “ [symbol] ”) is usually a composition of a surname followed by a given name.

The structure of the name “ [symbol] ” may be disassembled (block 250) into a surname “ [symbol] ” and a given name “ [symbol] ”. Then, the disassembled structure of the name components “ [symbol] ” and/or “ [symbol] ” may be verified with respect to actual real name information to generate a degree of confidence that the name is an actual real name (block 255). For example, the surname “ [symbol] ” may be compared with one or more lists or databases (e.g., blacklists or whitelists) of common or in-use Japanese surnames. In some example embodiments, the given name “ [symbol] ” may be compared with one or more lists or databases of common or in-use Japanese given names. A degree of confidence may be generated based on one or both comparisons. At block 260, if the degree of confidence is above a certain threshold (e.g., 51% or higher), the name “ [symbol] ” may be accepted (block 295, sub-process “A”). If not, process 200B may flow to sub-process “B”, as shown in FIG. 2B. Sub-process “B” is described above.

Alternate Example Process

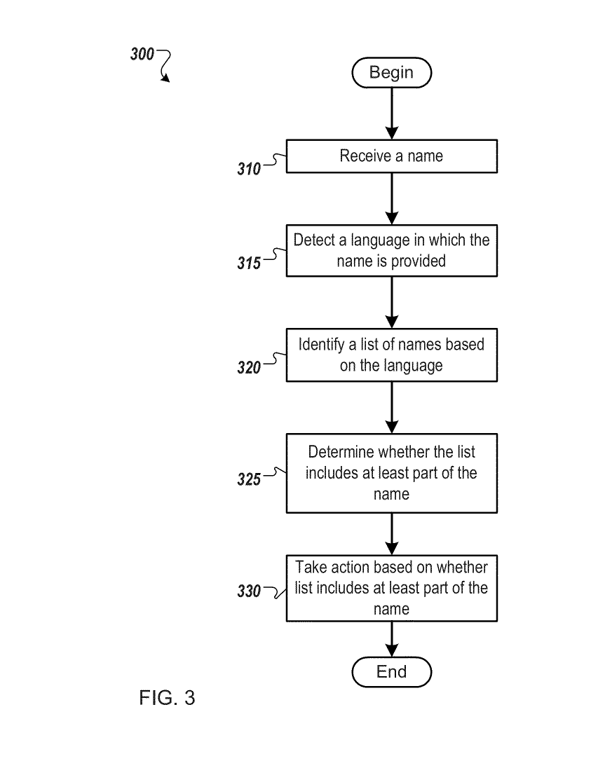

FIG. 3 shows yet another example process suitable for implementing at least one example embodiment. Process 300 illustrates one of many possible variations of process 200A. At block 310, a name is received. The name may be expressed in any human language. The language in which the name is provided is then evaluated and detected (block 315), to generate a language result. One or more lists (e.g., whitelist or blacklist, as explained above) of names and/or name components may be available per language. After detecting the language, a list of names and/or name components may be identified for the detected language (block 320). The list of names and/or name components may include or contain a part of the received name (block 325).

For example, the surname of the received name may be one of the commonly used surnames in a list; alternatively, the surname may be on a list of names that are not real names (e.g., blacklist). At block 330, action is taken based on whether the list includes at least part of the name. For example, in the case of a whitelist, if the name is on the whitelist, the name may then be accepted as real name or potential real name. Alternatively, in the case of a blacklist, if the name is on the list, then the name may be rejected as a non-real name or potential non-real name. The name may be recorded or saved, for example, in a database.

If the name is not in any lists (e.g., no component or part of the name is in any whitelist or blacklist), an action taken based on the determining may be to reject the name, with or without advancing to alternative mechanisms (e.g., as shown in FIG. 2B at blocks 273, 276, and/or 280) to determine whether the name is a real name.

In some examples, processes 200A, 200B, and 300 may be implemented with different, fewer, or more blocks. One or more of processes 200A, 200B, and 300 may be implemented as computer executable instructions, which can be stored on a medium, loaded onto one or processors of one or more computing devices, and executed as a computer-implemented method.

Example Computing Devices And Environments

FIG. 4 shows an example computing environment with an example computing device suitable for implementing at least one example embodiment. Computing device 405 in computing environment 400 can include one or more processing units, cores, or processors 410, memory 415 (e.g., RAM, ROM, and/or the like), internal storage 420 (e.g., magnetic, optical, solid state storage, and/or organic), and/or I/O interface 425, any of which can be coupled on a communication mechanism or bus 430 for communicating information or embedded in the computing device 405.

Computing device 405 can be communicatively coupled to input/user interface 435 and output device/interface 440. Either one or both of input/user interface 435 and output device/interface 440 can be a wired or wireless interface and can be detachable. Input/user interface 435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 440 may include a display, television, monitor, printer, speaker, braille, or the like. In some example embodiments, input/user interface 435 and output device/interface 440 can be embedded with or physically coupled to the computing device 405. In other example embodiments, other computing devices may function as or provide the functions of input/user interface 435 and output device/interface 440 for a computing device 405.

Examples of computing device 405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 405 can be communicatively coupled (e.g., via I/O interface 425) to external storage 445 and network 450 for communicating with any number of networked components, devices, and systems, including one or more computing devices of same or different configuration. Computing device 405 or any connected computing device can be functioning as, providing services of, or referred to as a server, client, thin server, general machine, special-purpose machine, or another label.

I/O interface 425 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 400. Network 450 can be any network or combination of networks (e.g., the Internet, local area network, wide area network, a telephonic network, a cellular network, satellite network, and the like).

Computing device 405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 405 can be used to implement techniques, methods, applications, processes, or computer-executable instructions to implement at least one embodiment (e.g., a described embodiment). Computer-executable instructions can be retrieved from transitory media, and stored on and retrieved from non-transitory media. The executable instructions can be originated from one or more of any programming, scripting, and machine languages (e.g., C, C++, C#, Java, Visual Basic, Python, Perl, JavaScript, and others).

Processor(s) 410 can execute under any operating system (OS) (not shown), in a native or virtual environment. To implement a described embodiment, one or more applications can be deployed that include logic unit 460, application programming interface (API) unit 465, input unit 470, output unit 475, language detection unit 480, verification unit 485, name determination unit 490, and inter-unit communication mechanism 495 for the different units to communicate with each other, with the OS, and with other applications (not shown). For example, language detection unit 480, verification unit 485, name determination unit 490 may implement one or more processes shown in FIGS. 2A-E and 3. The described units and elements can be varied in design, function, configuration, or implementation and are not limited to the descriptions provided.

In some example embodiments, when information or an execution instruction is received by API unit 465, it may be communicated to one or more other units (e.g., logic unit 460, input unit 470, output unit 475, language detection unit 480, verification unit 485, name determination unit 490). For example, after input unit 470 has received a name, input unit 470 may use API unit 465 to communicate the name to language detection unit 480. Language detection unit 480 may, via API unit 465, interact with the verification unit 485 to verify whether the name is real. Using API unit 465, verification unit 485 may interact with name determination unit 490, which may use one or more blacklists and/or whitelists to determine whether the name is real. In some example embodiments, verification unit 485 may use one or more mechanisms as described in sub-process “B”, FIG. 2B, to aid the determination of name.

In some examples, logic unit 460 may be configured to control the information flow among the units and direct the services provided by API unit 465, input unit 470, output unit 475, language detection unit 480, verification unit 485, name determination unit 490 in order to implement an embodiment described above. For example, the flow of one or more processes or implementations may be controlled by logic unit 460 alone or in conjunction with API unit 465.

Although a few example embodiments have been shown and described, these example embodiments are provided to convey the subject matter described herein to people who are familiar with this field. It should be understood that the subject matter described herein may be embodied in various forms without being limited to the described example embodiments. The subject matter described herein can be practiced without those specifically defined or described matters or with other or different elements or matters not described. It will be appreciated by those familiar with this field that changes may be made in these example embodiments without departing from the subject matter described herein as defined in the appended claims and their equivalents.

What is claimed is:

1. A computer-implemented method of detecting real names in different languages, comprising:
receiving, using one or more computing devices, a candidate name;
determining, using the one or more computing devices, a human language of the candidate name;
disassembling, using the one or more computing devices, a structure of the candidate name by applying a rule base for at least one of a character set, a meaning, and a format of the candidate name, wherein the rule base is unique to the determined human language;
verifying, using the one or more computing devices, at least a part of the disassembled structure of the candidate name with respect to actual real name information to generate a degree of confidence that the candidate name is an actual real name; and
performing, using the one or more computing devices, an action based on the generated degree of confidence that the candidate name is the actual real name.

2. The method of claim 1, wherein, when the generated degree of confidence is equal to or above a predefined threshold, the action comprises storing the candidate name as the actual real name.

3. The method of claim 1, wherein, when the generated degree of confidence is below a predefined threshold, the action comprises providing an indication that the candidate name is not accepted as the actual real name.

4. The method of claim 1, wherein the determining the human language of the candidate name comprises determining a script based on the Unicode Standard.

5. The method of claim 1, wherein the actual real name information comprises a whitelist of name information, and the verifying comprises comparing the at least a part of the disassembled structure of the candidate name with the whitelist of name information.

6. The method of claim 5, wherein the degree of confidence is generated at or above a threshold.

7. The method of claim 1, wherein the actual real name information comprises a blacklist of name information, and the verifying comprises comparing the at least a part of the disassembled structure of the candidate name with the blacklist of name information.

8. The method of claim 7, wherein the degree of confidence is generated below a threshold.

9. The method of claim 1, further comprising storing at least a part of the candidate name in a whitelist of name information.

10. The method of claim 1, further comprising storing at least a part of the candidate name in a blacklist of name information.

11. A non-transitory computer readable medium having stored therein computer executable instructions for:
receiving, using one or more computing devices, a candidate name;
determining, using the one or more computing devices, a human language of the candidate name;
disassembling, using the one or more computing devices, a structure of the candidate name by applying a rule base for at least one of a character set, a meaning, and a format of the candidate name, wherein the rule base is unique to the determined human language;
verifying, using the one or more computing devices, at least a part of the disassembled structure of the candidate name with respect to actual real name information to generate a degree of confidence that the candidate name is an actual real name; and
performing, using the one or more computing devices, an action based on the generated degree of confidence that the candidate name is the actual real name.

12. The computer readable medium of claim 11, wherein, when the generated degree of confidence is equal to or above a predefined threshold, the action comprises storing the candidate name as the actual real name.

13. The computer readable medium of claim 11, wherein, when the generated degree of confidence is below a predefined threshold, the action comprises providing an indication that the candidate name is not accepted as the actual real name.

14. The computer readable medium of claim 11, wherein the determining the human language of the candidate name comprises determining at least one script based on the Unicode Standard.

15. The computer readable medium of claim 11, wherein the actual real name information comprises a whitelist of name information, and the verifying comprises comparing the at least a part of the disassembled structure of the candidate name with the whitelist of name information.

16. At least one computing device comprising storage and at least one processor configured to perform:
receiving, using the at least one computing device, a candidate name;
determining, using the at least one computing device, a human language of the candidate name;
disassembling, using the at least one computing device, a structure of the candidate name by applying a rule base for at least one of a character set, a meaning, and a format of the candidate name, wherein the rule base is unique to the determined human language;
verifying, using the at least one computing device, at least a part of the disassembled structure of the candidate name with respect to actual real name information to generate a degree of confidence that the candidate name is an actual real name; and
performing, using the at least one computing device, an action based on the generated degree of confidence that the candidate name is the actual real name.

17. The at least one computing device of claim 16, wherein, when the generated degree of confidence is equal to or above a predefined threshold, the action comprises storing the candidate name as the actual real name.

18. The at least one computing device of claim 16, wherein, when the generated degree of confidence is below a predefined threshold, the action comprises requesting verification information to support that the candidate name is the actual real name.

19. The at least one computing device of claim 16, wherein the determining the human language of the candidate name comprises determining a two scripts based on the Unicode Standard, wherein the human language is determined based on the two scripts.

20. The at least one computing device of claim 16, further comprising receiving the verification information that indicates the candidate name is the actual real name.
